(19) United States
(12) Patent Application Publication
(10) Pub. No.: US 2026/0018970 A1
(43) Pub. Date: Jan. 15, 2026

(54) ROTOR ASSEMBLY WITH COOLING STRUCTURE

(71) Applicant: HYUNDAI MOBIS CO., LTD., Seoul (KR)

(72) Inventor: Dae Wook KIM, Yongin-si (KR)

(73) Assignee: HYUNDAI MOBIS CO., LTD., Seoul (KR)

(21) Appl. No.: 19/237,509

(22) Filed: Jun. 13, 2025

(30) Foreign Application Priority Data
Jul. 10, 2024 (KR) 10-2024-0090833

(51) Int. Cl. H02K 9/22; H02K 9/19

(52) U.S. Cl. CPC H02K 9/225; H02K 9/19

(57) ABSTRACT

The disclosure relates to a rotor assembly, and more particularly to a rotor assembly with the cooling structure. The rotor assembly with the cooling structure according to the disclosure has been conceived to solve the foregoing problems, and the disclosure rotor assembly with the cooling structure has effects on cooling a rotor core more intensively as a cooling bar formed extending in an axial direction is inserted into the rotor core, reducing the torque loss of a motor significantly as the demagnetization of a magnet embedded in the rotor core is decreased, and cooling the rotor core without using the interior of a shaft when a motor shaft and a drive shaft have the same axis like an on-axis casing.

### CROSS REFERENCE TO RELATED APPLICATION

The present application claims priority to Korean Patent Application No. 10-2024-0090833, filed Jul. 10, 2024, the entire contents of which is incorporated herein for all purposes by this reference.

### BACKGROUND OF THE INVENTION

### Field of the Invention

The disclosure relates to a rotor assembly, and more particularly to a rotor assembly with the cooling structure.

### Description of the Related Art

The heat of an electric motor for driving an electric vehicle is generated by a coil where current flows and an electrical steel core where magnetic flux flows. When the motor operates, the temperature of those components rises. When the temperature rises excessively, the motor malfunctions. To prevent the malfunction, it is important to cool the heat source of the motor. The motor employs an oil cooling method that directly sprays oil onto the heat source, a water-cooling method that indirectly cool the heat source by flowing cooling water through a housing water channel, or etc.

However, with the increased specifications of the motor, high rotation and high current have been applied to the motor, and thus a considerable amount of heat has been generated in a rotor. Nevertheless, conventional cooling has been performed focusing on a stator assembly and a coil rather than a rotor assembly, and partially used for the lubrication and cooling of a reducer and a bearing. Accordingly, there was a problem that the increased temperature of the rotor causes the magnet to be demagnetized and lowered in performance. More specifically, as the temperature of the rotor assembly is increased by 10 degrees, a loss of 1.3% torque [Nm] has occurred, thereby lowering the overall efficiency and specifications of the motor.

Further, when a motor axis and a drive shaft axis are the same like an on-axis as a drive shaft is fitted into the center of a rotor shaft, there were problems that a shaft having high axial direction thermal conductivity could not be used due to the hollow shaft has a large cross-sectional area like SG2 (i.e., a conventional shaft), and the inside of the shaft could not be used as a cooling channel for a cooling fluid due to fluid resistance.

### DOCUMENTS OF RELATED ART

(Patent Document 1) Korean Patent No. 10-2153232, titled “motor provided with cooling system,” and registered on Sep. 1, 2020.

### SUMMARY OF THE INVENTION

The disclosure has been conceived to solve the foregoing problems, and an aspect of the disclosure is to provide a rotor assembly with a cooling structure, in which a cooling bar formed extending in an axial direction is inserted into a rotor core to more intensively cool the rotor core, and the demagnetization of a magnet embedded in the rotor core is decreased to significantly reduce the torque loss of a motor.

Another aspect of the disclosure is to provide a rotor assembly with a cooling structure, in which a rotor core is cooled through a cooling bar inserted into the rotor core without using the interior of a shaft when a motor shaft and a drive shaft have the same axis like an on-axis casing.

According to an embodiment of the disclosure, a rotor assembly with a cooling structure includes: a rotor core shaped like a cylinder and including a hollow hole formed penetrating a center thereof to fit a rotor shaft of a motor thereto; and a cooling bar inserted in the rotor core and cooling the rotor core while conducting heat inside the rotor core in an axial direction.

The rotor core may include: two or more stairs stacked in the axial direction; and at least one insertion hole formed in each stair of the rotor core, formed at a position spaced apart at a predetermined distance from the hollow hole in a radial direction, and formed penetratingly along the axial direction, the adjacent insertion holes are formed having at least partially overlapping areas, and the cooling bars are inserted into the insertion holes in one-to-one correspondence, respectively.

The insertion hole may be formed at a position closer to the hollow hole than to an outer surface of the rotor core.

The insertion hole may be formed at a position spaced apart at a predetermined distance from a region where a magnet is inserted in the rotor core toward the hollow hole.

An even number of four or more insertion holes may be formed, and the cooling bars may be inserted in all the insertion holes, respectively, and the insertion holes may be equidistantly spaced apart from each other along a circumferential direction.

Three or more insertion holes may be formed, and the cooling bars may be inserted in all the insertion holes, respectively, and the insertion holes may be equidistantly spaced apart from each other along a circumferential direction.

The rotor core may include a thermally-conductive plate shaped like a flat plate stacked on both ends thereof in the axial direction, and the thermally-conductive plate may be used as a shield in a region to be in contact with the insertion hole, and come into surface-contact with the end of the cooling bar in the axial direction.

The rotor core may include a thermally-conductive plate shaped like a flat plate stacked on both ends thereof in the axial direction, and the thermally-conductive plate may be formed with a plate hole in a region corresponding to the insertion hole, and a lateral surface of the cooling bar is in surface-contact with an inner surface of the plate hole.

The cooling bar and the thermally-conductive plate may contain at least one of a material that is a nonconductor but has a thermal conductivity higher than or equal to a predetermined first reference value, or a material that has lower electrical resistance than iron but has a thermal conductivity higher than or equal to a second reference value lower than the first reference value.

The rotor assembly may further include a spray to spray cooling oil to the rotor core, wherein the spray sprays the cooling coil to both axial ends of the rotor core.

### BRIEF DESCRIPTION OF THE DRAWINGS

FIG. 1 is an axial-section view of a rotor assembly with a cooling structure according to the disclosure.

FIG. 2 is an axial-section view of a rotor assembly with a cooling structure according to the disclosure, in which a heat conduction direction is illustrated.

FIG. 3 is a cross-section view of rotor assembly with a cooling structure according to the disclosure, which is cut in a direction perpendicular to an axis.

FIG. 4 is a partial cross-section view of a rotor assembly with a cooling structure according to the disclosure.

FIG. 5 is a partial axial-section view of a rotor assembly with a cooling structure according to the disclosure.

### DETAILED DESCRIPTION OF THE INVENTION

Hereinafter, the technical idea of the disclosure will be described in more detail with reference to the accompanying drawings. Prior to the description, the terms or words used in this specification and the appended claims should not be construed as limited to general and lexical meanings, but interpreted as the meanings and concepts corresponding to the technical idea of the disclosure based on the principle that the inventor can define terms appropriately for the best description.

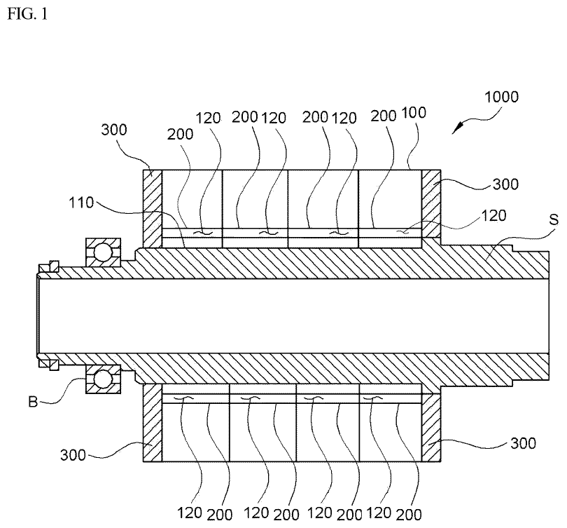

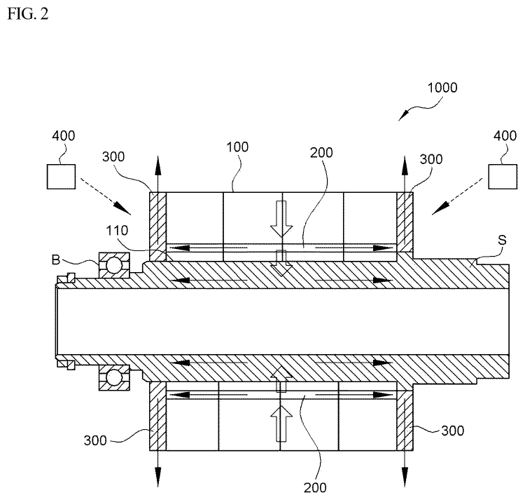

Below, the configuration of a rotor assembly 1000 with a cooling structure according to the disclosure will be described with reference to FIGS. 1 and 2.

As shown in FIG. 1, the rotor assembly 1000 with the cooling structure according to the disclosure may include a rotor core 100 shaped like a cylinder having a hollow hole 110 formed penetrating the center thereof to insert a shaft S of a motor therein. The rotor core 100 may be made of iron, and generate a magnetic field with a magnet M embedded therein. In addition, the rotor assembly 1000 with the cooling structure according to the disclosure may include a cooling bar 200 inserted in the rotor core 100. The cooling bar 200 may include a cooling bar 200 that conducts heat inside the rotor core 100 in an axial direction and cools the rotor core 100. The cooling bar 200 may be inserted in the rotor core 100 by hot or cold press-fitting.

In this case, the cooling bar 200 may contain at least one of a material that is a nonconductor but has the highest thermal conductivity, or a material that has lower electrical resistance than iron but has high thermal conductivity. More specifically, the cooling bar 200 may contain at least one of a material that is the nonconductor but has a thermal conductivity higher than or equal to a predetermined first reference value, or a material that has lower electrical resistance than iron but has a thermal conductivity higher than or equal to a second reference value lower than the first reference value. For example, the cooling bar 200 may contains copper or aluminum. With the cooling bar 200 that contains copper or aluminum, the magnetic flux of the rotor core 100 may not move well through the cooling bar 200, and thus the eddy current loss and resulting heat generation occurring in the rotor core 100 may be reduced centering around the cooling bar 200. Further, with the cooling bar 200 that contains copper or aluminum, heat may move centering around the cooling bar 200, and thus be dispersed and dissipated to both ends of the rotor core 100.

In this way, the cooling bar 200 inserted in the rotor core 100 may cool the rotor core 100 more Consistently and stably than a conventional cooling method using cooling oil. The shorter the length of the rotor core 100 in the axial direction, the shorter a heat conduction distance. Therefore, the cooling bar 200 has a higher heat transfer efficiency than the cooling oil.

Further, as shown in FIG. 2, the rotor assembly 1000 with the cooling structure according to the disclosure may further include a spray 400 that sprays cooling oil to the rotor core 100. The spray 400 may spray the cooling oil to both axial ends of the rotor core 100 in the dotted line direction of FIG. 2. Accordingly, both ends of the cooling bar 200 inserted into the rotor core 100 may be cooled by the cooling oil, and heat in a center portion of the rotor core 100 may be more smoothly transferred to both ends of the rotor core 100 during a thermal equilibrium process. More specifically, the heat may be transferred and distributed along the solid line arrows of FIG. 2.

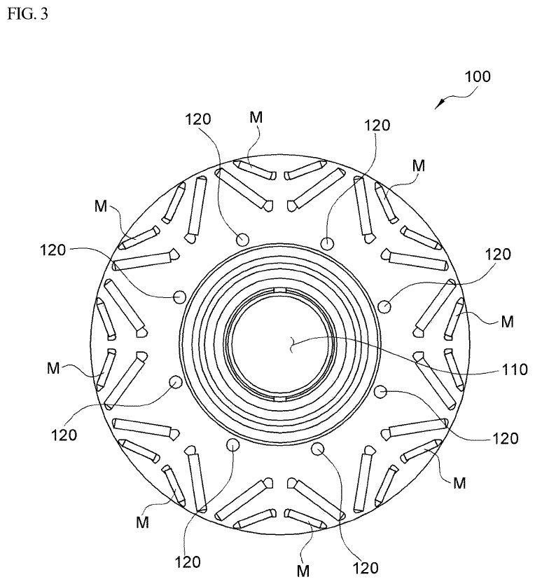

Below, the cooling bar 200 and other components according to the disclosure will be described in more detail with reference to FIGS. 3 to 5.

As shown in FIG. 3, the rotor core 100 includes at least one insertion hole 120 formed at a position spaced apart at a predetermined distance from the hollow hole 110 in a radial direction and formed penetratingly along the axial direction, so that the cooling bar 200 can be inserted into the insertion hole 120. In this case, the insertion holes 120 may be respectively formed in the multilevel stairs of the rotor core 100 stacked along the axial direction, and the adjacent insertion holes 120 may be formed having at least partially overlapping areas. In this case, the cooling bars 200 may be inserted into the insertion holes 120, respectively. Thus, heat may be conducted through the overlapping area between the cooling bars 200 of the adjacent stairs of the rotor core 100. In this case, the cross-section of the insertion hole 120 or cooling bar 200 in the direction perpendicular to the axial direction may be shaped like an oval with pointed opposite ends, rather than a circle.

Further, the diameter of the insertion hole 120 may be smaller than the diameter of the cooling bar 200 by a predetermined value, and thus the cooling bar 200 may be inserted in the insertion hole 120 by the cold or hot press-fitting. Accordingly, the cooling bar 200 and the rotor core 100 are coupled more firmly.

Further, an even number of four or more insertion holes 120 may be formed, or three or more insertion holes 120 may be formed. In this case, the insertion holes 120 may be equidistantly spaced apart from each other along a circumferential direction, and may be spaced apart from each other with a central angle of at least 120 degrees therebetween. In addition, the cooling bars 200 are inserted into all the insertion holes 120, and the insertion holes 120 may be equidistantly spaced apart from each other along the circumferential direction. Accordingly, heat generated in the rotor core 100 may be uniformly distributed to the outside.

In addition, as shown in FIG. 3, the insertion hole 120 may be formed closer to the hollow hole 110 than to the outer surface of the rotor core 100. Because the insertion hole 120 is formed closer to the hollow hole 110, i.e., closer to the center portion, the multilevel stairs of the rotor core 100 are easily connected by the cooling bar 200 inserted in the insertion hole 120 and completely penetrating the rotor core 100. Further, because the insertion hole 120 is formed on the side of the hollow hole 110, a position where the magnet M is placed may be separated from an area where the cooling bar 200 is press-fitted, and a space in which the thicker cooling bar 200 is be inserted may be secured. Accordingly, the cooling bar 200 having a diameter of 6 mm or more may be inserted, and thus the heat conductive cross-sectional area increases, thereby carrying out the heat conduction more smoothly.

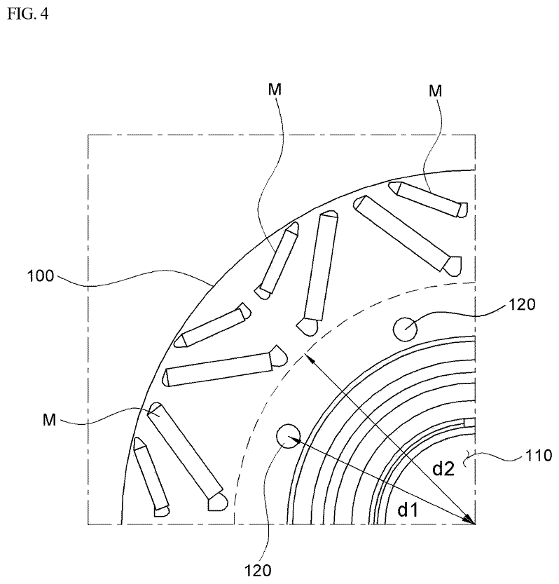

More specifically, as shown in FIG. 4, the insertion hole 120 may be formed at a position spaced apart at a predetermined distance from a region where the magnet M is inserted in the rotor core 100 toward the hollow hole 110. More specifically, when a distance d1 is given between the center of the hollow hole 110 and the center of the insertion hole 120 and a distance d2 is given between the center of the hollow hole 110 and the end of the magnet M facing the hollow hole 11, d1 may be smaller than d2. Accordingly, the magnet M may be spaced apart from the cooling bar 200 through which heat is transferred, and thus heat transferred from the cooling bar 200 to the magnet M is minimized, thereby minimizing the demagnetization of the magnet M.

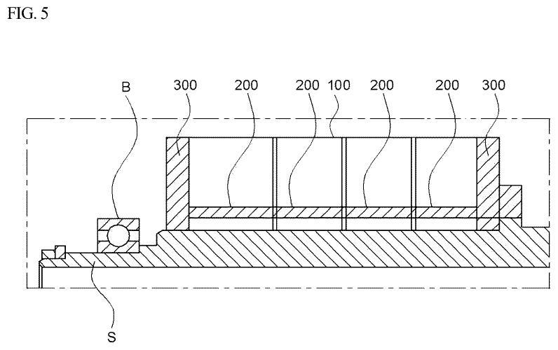

Further, as shown in FIG. 5, the cooling bar 200 may be formed to extend in a straight line along the axial direction and be inserted to completely penetrate the rotor core 100. Thus, the multilevel stairs of the rotor core 100 stacked along the axial direction are easily connected.

Further, the rotor core 100 may include a thermally-conductive plate 300 shaped like a flat plate stacked on both ends thereof in the axial direction. The thermally-conductive plate 300 may contain a material that has electrical resistance lower than that of iron and thermal conductivity higher than that of iron. For example, the thermally-conductive plate 300 may be made of copper or aluminum. The thermally-conductive plate 300 may allow the heat of the cooling bar 200 to be more easily distributed, and may also be utilized for (-) balancing.

In more detail, the thermally-conductive plate 300 may be used as a shield in a region to be in contact with the insertion hole 120, thereby coming into surface-contact with the end of the cooling bar 200 in the axial direction. In other words, the thermally-conductive plate 300 may be stacked on the rotor core 100 after the cooling bar 200 is press-fitted into the rotor core 100. Thus, the thermally-conductive plate 300 may prevent the cooling bar 200 from breaking away or from coming into direct contact with an external component.

Alternatively, the thermally-conductive plate 300 may be formed with a plate hole in a region corresponding to the insertion hole 120, so that the lateral surface of the cooling bar 200 can be in surface-contact with the inner surface of the plate hole. In other words, the thermally-conductive plate 300 may be stacked on the rotor core 100 before the cooling bar 200 is press-fitted into the rotor core 100, and then the cooling bar 200 may be press-fitted into the thermally-conductive plate 300 and the rotor core 100. Accordingly, a contact area between the cooling bar 200 and the thermally-conductive plate 300 is increased, thereby achieving smooth heat conduction to the thermally-conductive plate 300.

With the foregoing configuration, the rotor assembly with the cooling structure has effects on cooling a rotor core more intensively as a cooling bar formed extending in an axial direction is inserted into the rotor core, and reducing the torque loss of a motor significantly as the demagnetization of a magnet embedded in the rotor core is decreased.

Another aspect of the disclosure is to provide a rotor assembly with a cooling structure, in which a rotor core is cooled through a cooling bar inserted into the rotor core without using the interior of a shaft when a motor shaft and a drive shaft have the same axis like an on-axis casing.

The disclosure should not be interpreted as limited to the aforementioned embodiments of the disclosure. The disclosure is variously applicable, and various modifications can be made by those skilled in the art without departing from the scope of the disclosure defined in the appended claims. Accordingly, such improvements and modifications fall within the scope of the disclosure as long as they are obvious to those skilled in the art.

### DESCRIPTION OF REFERENCE NUMERALS

1000: rotor assembly with the cooling structure
100: rotor core
110: hollow hole
120: insertion hole
130: recessed groove
200: cooling bar
300: thermally-conductive plate
400: spray
S: rotor shaft
M: magnet
B: bearing

What is claimed is:

1. A rotor assembly with a cooling structure, comprising:
a rotor core shaped like a cylinder and comprising a hollow hole formed penetrating a center thereof to fit a rotor shaft of a motor thereto; and
a cooling bar inserted in the rotor core and configured to cool the rotor core while conducting heat inside the rotor core in an axial direction.

2. The rotor assembly of claim 1, wherein
the rotor core comprises:
two or more stairs stacked in the axial direction; and
at least one insertion hole formed in each stair of the rotor core, formed at a position spaced apart at a predetermined distance from the hollow hole in a radial direction, and extending along the axial direction,
the adjacent insertion holes are formed having at least partially overlapping areas, and
a cooling bar is inserted into each insertion hole in one-to-one correspondence, respectively.

3. The rotor assembly of claim 2, wherein the insertion hole is formed at a position closer to the hollow hole than to an outer surface of the rotor core.

4. The rotor assembly of claim 3, wherein the insertion hole is spaced apart at a predetermined distance from a region where a magnet is inserted in the rotor core toward the hollow hole.

5. The rotor assembly of claim 2, wherein
an even number of four or more insertion holes are formed, and cooling bars are inserted in all the insertion holes, respectively, and
the insertion holes are evenly spaced apart along a circumferential direction.

6. The rotor assembly of claim 2, wherein
three or more insertion holes are formed, and cooling bars are inserted in all the insertion holes, respectively, and
the insertion holes are evenly spaced apart along a circumferential direction.

7. The rotor assembly of claim 2, wherein
the rotor core comprises a thermally-conductive plate shaped like a flat plate stacked on both ends thereof in the axial direction, and
the thermally-conductive plate is used as a shield in a region to be in contact with the insertion hole, and comes into surface-contact with the end of the cooling bar in the axial direction.

8. The rotor assembly of claim 7, wherein the cooling bar and the thermally-conductive plate contain at least one of a material that is a nonconductor but has a thermal conductivity higher than or equal to a predetermined first reference value, or a material that has lower electrical resistance than iron but has a thermal conductivity higher than or equal to a second reference value lower than the first reference value.

9. The rotor assembly of claim 2, wherein
the rotor core comprises a thermally-conductive plate shaped like a flat plate stacked on both ends thereof in the axial direction, and
the thermally-conductive plate is formed with a plate hole in a region corresponding to the insertion hole, and a lateral surface of the cooling bar is in surface-contact with an inner surface of the plate hole.

10. The rotor assembly of claim 9, wherein the cooling bar and the thermally-conductive plate contain at least one of a material that is a nonconductor but has a thermal conductivity higher than or equal to a predetermined first reference value, or a material that has lower electrical resistance than iron but has a thermal conductivity higher than or equal to a second reference value lower than the first reference value.

11. The rotor assembly of claim 1, further comprising a spray to spray cooling oil to the rotor core, wherein
the spray sprays the cooling oil to both axial ends of the rotor core.
